(19) United States
(12) Patent Application Publication
(10) Pub. No.: US 2010/0085594 A1
(43) Pub. Date: Apr. 8, 2010

(54) PRINTER-RESIDENT DEFAULT JOB TICKET

(76) Inventor: David A. Williams, San Jose, CA (US)

Correspondence Address: DUFT BORNSEN & FISHMAN, LLP, 1526 SPRUCE STREET, SUITE 302, BOULDER, CO, 80302, US

(21) Appl. No.: 12/245,891

(22) Filed: Oct. 6, 2008

(51) Int. Cl. G06F 3/12

(52) U.S. Cl. 358/1.15

(57) ABSTRACT

A print controller in a printing system includes a storage system that stores a default job ticket. The print controller also includes a reduced-job-ticket interpreter. The print controller receives a printable file from a host system. The reduced-job-ticket interpreter receives a reduced job ticket associated with the printable file and builds a final job ticket using data from the reduced job ticket and the default job ticket. The print controller then prints the printable file in accordance with the final job ticket. In some embodiments, the print controller receives a PostScript printable file from the host system and the reduced-job-ticket interpreter receives a reduced job ticket in JDF format

### BACKGROUND

1. Field of the Invention

The invention relates to the field of printing systems, and in particular, to processing job tickets in a printing system to identify printing parameters that define how to print content files.

2. Discussion of Related Art

Printing systems generally include a localized print controller that connects to one or he more host systems. The print controller controls the overall operation of the printing system including, for example, host interfacing, interpretation or rendering of the content for each page of a document, and lower level process control or interface features of the print engine of the printing system. Host interaction may include appropriate adapters for coupling the printing system to one or more host systems that transmit printable files to the printing system. The printable files (also referred to as print data files or content files, among other designations) are generally encoded in the form of a page description language (PDL), such as PostScript (PS), Printable Document Format (PDF), Printer Command Language (PCL), etc.

In whatever form the printable files may be encoded or formatted, the print controller within the printing system interprets or renders the file to generate sheetside bitmaps of the file. For example, the printable file may include page descriptions for each logical page of the file encoded in a particular PDL. The print controller may then interpret the page descriptions for each page to generate the sheetside bitmaps to be applied to the printing engine to imprint on the printable medium. The sheetside bitmaps represent the images to be printed on one side of a sheet of paper by a print engine. The print controller stores or buffers the sheetside bitmaps in accordance with storage capabilities of the particular print controller. The print controller then forwards the sheetside bitmaps to one or more print engines (also referred to as an imaging engine or as a marking engine) for printing the sheetside bitmaps on the printable medium.

In conventional printing systems, when the host system is instructed to print a particular file comprised of textual and graphical content, the host system converts the file into a printable file in one of a variety of PDLs. The host system also generates printing parameters (also referred to as device control commands or instructions) with the printable file providing parameters to be applied when imprinting the resultant bitmap images.

One way of describing the printing parameters for a print job is through creation of a job ticket. A job ticket defines a print job and associates one or more printable files with information that defines various printing parameters for actual physical printing of the printable files. Among other things, a job ticket may include layout parameters indicative of where each logical page defined by the PDL of the printable files is to be placed on a sheetside of the printable medium. One common standard format for encoding a job ticket is the Job Definition Format (JDF), which is presently defined by the CIP4 Organization and known to those skilled in the art. A JDF job ticket is defined in Extensible Markup Language (XML) syntax.

In conventional printing systems, processing of JDF job tickets is performed in the host system (e.g., an application computer system, a printer server computing node, etc.). In response to receiving or identifying a JDF job ticket, the host system processes the JDF job ticket to identify the printing parameters for a print job. The host system then generates a printable file in the appropriate PDL that includes the content intended for printing and also includes the printing parameters defined in the job ticket to modify or adjust the actual printed output. This can cause problems as it may overload the host system in processing the JDF job ticket and generating the printable files. Depending on the parameters defined in the job tickets, data in one or more print files may be replicated to achieve the desired physical imprinting layout. In such a scenario the printable files with the included printing parameters can get quite large requiring significant processing and storage resources in the host system that is intended for numerous other functions. Also, if a network connection is used between the host system and the printing system, then the large volume of data (e.g., the printable files including any replicated data generated by the job ticket print parameters) may congest the network or unnecessarily use up network resources.

To alleviate such problems, co-owned and co-pending U.S. patent application Ser. No. 12/118,191, filed May 9, 2008 (hereinafter the '191 patent), teaches a printing system that processes job tickets in the printing system instead of within a host system. Thus, the host system may transmit a job ticket and the related printable files to the printing system for processing, instead of processing the job ticket locally on the host system. Thus, the volume of data processed by the host system and transmitted to the printing system may be reduced. The print controller in the printing system then processes the job ticket to identify the printing parameters defined in the job ticket, and controls printing of the printable file based on the identified printing parameters. The processing of job tickets is advantageously moved from the host system to the printing system, which relieves the processing responsibility from the host system and avoids transmitting a large volume of data over a network.

In one common field of production printing, print jobs often consist of one or more printable files and a job ticket, as described above. In particular, the layout and imposition parameters of the job ticket may define a new placement, size and orientation for the printed pages that is different from what is described in the PDL printable file. On the other hand, the printing parameters of many print jobs being processed by a printing system may be substantially identical or similar from one print job to the next. Thus, many job tickets may have common elements. For example, especially in the field of production printing, many jobs will use a common paper size or will specify common layout or finishing options. Regardless, an entire job ticket is transmitted to the job-ticket processing system for each print job. Thus, for a printing system as described above, in which job-ticket processing is printer-based and a job ticket is transmitted to the printer for each job, many common job ticket elements are repeatedly transmitted to the printer. Accordingly, improved techniques are needed for reducing the amount of information that is repeatedly transmitted in numerous job tickets.

### SUMMARY OF THE INVENTION

Embodiments of the present invention help to solve some of the problems described above by providing systems and methods in which a default job ticket (or set of default job tickets) is stored in the printer. The settings stored in a default job ticket are also known to the software that prepares the print job on the host. Embodiments in accordance with the present invention allow the host to send a reduced job ticket, which only specifies the differences between the current job requirements and the default parameters contained in a default job ticket. Thus, the printer-based job-ticket interpreter can build a final job ticket using data from the reduced job ticket and the default job ticket. Since the job-ticket interpreter has a local copy of the default job ticket, it uses the default job ticket to supply the missing elements of the reduced job ticket received from the host. Thus, the printer-based job-ticket interpreter may generate a final job ticket to process even though only a reduced (or partial) job ticket was transmitted from the host. These features save network bandwidth because the partial job ticket is smaller than the final job ticket and also may conserve resources (processing and storage) on the attached host system that previously processed the hob ticket information.

A basic embodiment of a print controller in a printing system in accordance with the invention includes: a storage system operable to store a default job ticket, and a reduced-job-ticket interpreter. The print controller is operable to receive a printable file from a host system. The reduced-job-ticket interpreter is operable to receive a reduced job ticket that is associated with the printable file from the host system. The reduced-job-ticket interpreter is also operable to build a final job ticket using data from the reduced job ticket and a default job ticket. The print controller is operable to print the printable file in accordance with the final job ticket. In some embodiments, the print controller is operable to receive a PostScript printable file from the host system. In some embodiments, the reduced-job-ticket interpreter is operable to receive a JDF (Job Definition Format) reduced job ticket. In some embodiments, the print controller further comprises a page-description-language (PDL) interpreter operable to interpret the printable file. The reduced-job-ticket interpreter may comprise a program interpreted by the PDL interpreter. In some embodiments, the storage system is operable to store a JDF (Job Definition Format) default job ticket, the print controller is operable to receive a PostScript printable file from the host system, the PDL interpreter comprises a PostScript interpreter, and the reduced-job-ticket interpreter comprises a program interpreted by the PostScript interpreter. In some embodiments, the reduced-job-ticket interpreter comprises a JDF interpreter, and the default job ticket contains PostScript commands that are useful by the reduced-job-ticket interpreter to build the final job ticket. In some embodiments, the reduced-job-ticket interpreter comprises a JDF interpreter, and the default job ticket contains internal format commands that are useful by the reduced-job-ticket interpreter to build the final job ticket.

An exemplary embodiment of a method in accordance with the invention for processing job tickets in a printing system comprises: receiving a printable file from a host system; receiving a reduced job ticket associated with the printable file; building a final job ticket using data from the reduced job ticket and data from a default job ticket stored in the printing system; and printing the printable file in accordance with the final job ticket. In some embodiments, receiving the printable file comprises receiving a PostScript printable file. In some embodiments, receiving the reduced job ticket comprises receiving a reduced JDF job ticket.

The invention may include other exemplary embodiments described below.

### BRIEF DESCRIPTION OF THE DRAWINGS

The same reference number represents the same element or same type of element on all drawings.

FIG. 1 illustrates a printing environment in an exemplary embodiment of the invention.

FIG. 2 is a flowchart illustrating an exemplary method of processing a default job ticket and a reduced job ticket in an exemplary embodiment of the invention.

FIG. 3 illustrates another printing environment in an exemplary embodiment of the invention.

FIG. 4 is a flowchart illustrating an exemplary method of processing JDF job tickets in accordance with the invention.

### DETAILED DESCRIPTION OF THE DRAWINGS

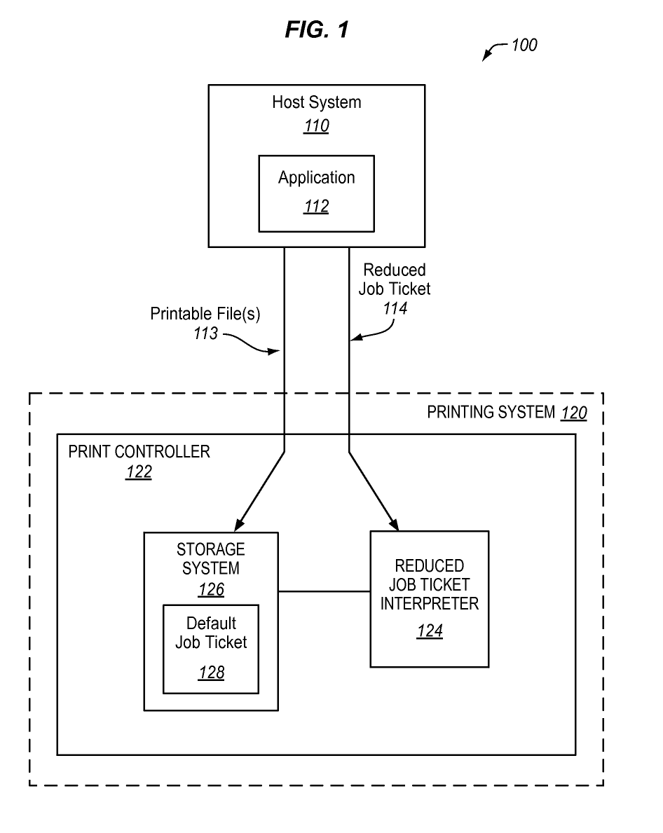

FIGS. 1 through 4 and the following description disclose specific exemplary embodiments of the present invention to teach those skilled in the art how to make and use the invention. For the purpose of this teaching, some conventional aspects of the invention have been simplified or omitted. Those skilled in the art will appreciate variations from these embodiments that fall within the scope of the present invention. Those skilled in the art will appreciate that the features described below can be combined in various ways to form multiple variations of the present invention. As a result, the invention is not limited to the specific embodiments described below, but only by the claims and their equivalents.

FIG. 1 illustrates a printing environment 100 in an exemplary embodiment of the invention. Printing environment 100 includes one or more host systems 110 in communication with a printing system 120. Host system 110 comprises any computer, server, or other device operable to execute programmed instructions including, for example, an application 112 to generate or provide printable files 113. A printable file 113 comprises any digital file having text, images, or other content to be printed on printing system 120. The printable files 113 may be formatted in any of a variety of page description languages (PDLs), such as PostScript (PS), Printable Document Format (PDF), Printer Command Language (PCL), etc. Host system 110 may also generate or receive a reduced job ticket 114 that is associated with a printable file. A reduced job ticket 114 comprises any data that defines completely or partially for a print job how one or more related printable files 113 are to be processed for printing, such as the type of printable media to be used in printing a file, the size of pages in the file, alignment of graphics or text on the pages, the type of finishing for the pages, etc. When host system 110 submits a print job to printing system 120, host system 110 transmits printable files 113 and a reduced job ticket 114 to printing system 120. Alternatively, the reduced job ticket may include an address or an indicator of the location of a printable file, and printing system 120 may retrieve the printable file.

Printing system 120 comprises any system used to imprint bitmap images on a printable medium. Printing system 120 may comprise any printing system including ink-jet, electrophotographic, etc. and including small systems oriented for personal use ranging through high end production printing systems (e.g., a continuous forms printer or a cut sheet page printer) adapted to print at higher rates. Printing system 120 includes a print controller 122. Print controller 122 comprises any system, server, or components operable to control the printing of files on printing system 120.

Print controller 122, in one exemplary embodiment, comprises a reduced-job-ticket interpreter 124 and a storage system 126. In accordance with the invention, a default job ticket 128 is stored in storage system 126. In system 100, print controller 122 is operable to receive one or more printable files 113 from an attached host system 110. Reduced-job-ticket interpreter 124 is operable to receive from an attached host system 110 a reduced job ticket 114 that is associated with the one or more printable files 113 to define a print job. Reduced-job-ticket interpreter 124 is further operable to build a final job ticket using data from the reduced job ticket 114 and data from a default job ticket 128. Storage system 126 comprises any system, server, or components operable to receive printable files 113 for printing, and to store or queue the files. Storage system 126 may comprise a disk drive or other suitable storage means. Reduced-job-ticket interpreter 124 comprises any system, server, or components operable to receive and process a reduced job ticket 114 and to build a final job ticket using data from reduced job ticket 114 and data from default job ticket 128. Print controller 122 is operable to process and print printable files 113 in accordance parameters defined by the final job ticket. Although not shown, print controller 122 may include other components for processing raw data for a file, components for rendering or interpreting the raw data to generate bitmaps, and components for queuing or buffering the bitmaps for subsequent transfer to a print engine.

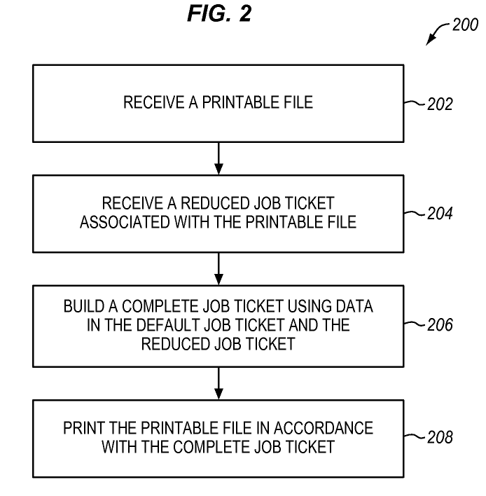

FIG. 2 is a flowchart illustrating an exemplary embodiment of a method 200 of processing a default job ticket and a reduced job ticket in printing system 120 in accordance with the invention. The steps of method 200 will be described with reference to printing system 120 in FIG. 1, although method 200 may be performed by other systems. The steps of the flowchart in FIG. 2 are not all inclusive and may include other steps not shown.

In step 202, print controller 122 receives one or more PDL printable files. The printable files may be received from host system 110 as illustrated in FIG. 1, or may be received from another system or server or any other suitable device. In step 204, reduced-job-ticket interpreter 124 receives a reduced job ticket from host system 110 or another system. The reduced job ticket is associated with one or more printable files. In step 206, reduced-job-ticket interpreter 124 builds a final job ticket using data in a default job ticket stored in storage system 126 together with data in the reduced job ticket. In step 208, print controller 122 prints the printable file in accordance with the final job ticket.

Many print controllers include PostScript interpreters that are operable to interpret files and programs coded according to the PostScript language. The following illustrates a specific embodiment of implementing a JDF interpreter as a PostScript program. Although PostScript will be described in the following embodiment, other languages may be used to implement a JDF interpreter in other embodiments.

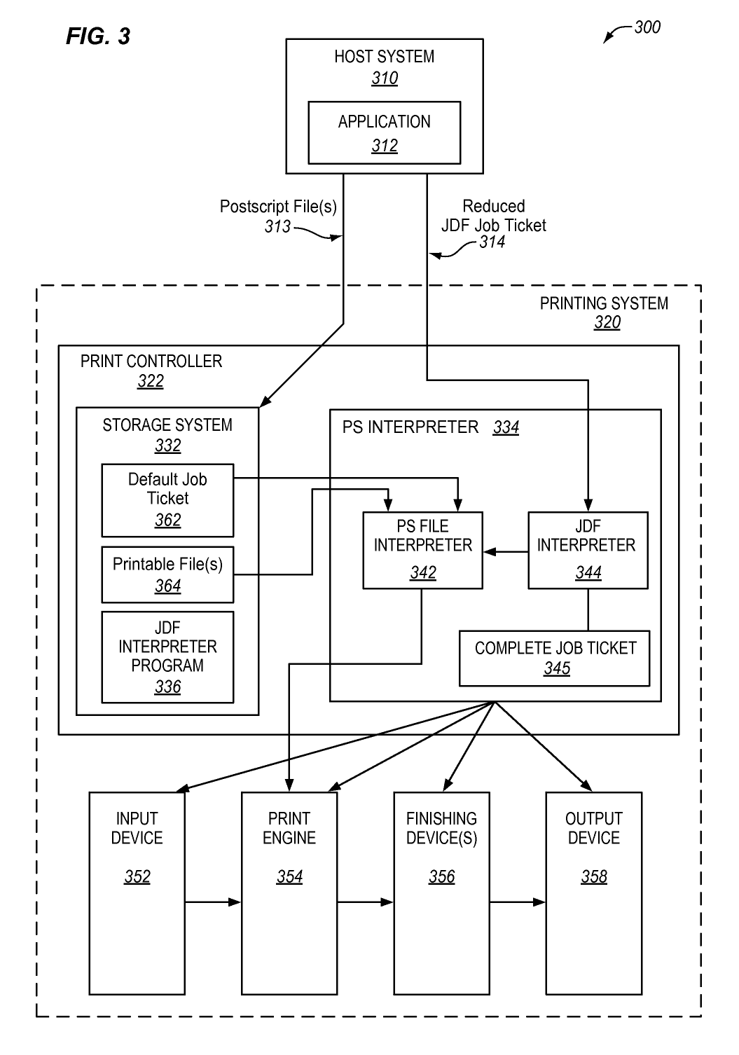

FIG. 3 illustrates another printing environment 300 in an exemplary embodiment of the invention. Printing environment 300 includes one or more host systems 310 in communication with a printing system 320. Host system 310 is able to execute an application 312 to generate or provide one or more PostScript printable files 313 to printing system 320. Printing system 320 includes a print controller 322, an input device 352, one or more print engines 354, one or more finishing devices 356, and an output device 358. Print controller 322 is operable to process reduced JDF job tickets 314 received from host system 310 or another system. Print controller 332 also is operable to process JDF default job tickets. To provide such functionality, print controller 322 includes a storage system 332 and a PostScript interpreter 334. As depicted in FIG. 3, storage system 332 is operable to store default job ticket(s) 362 and the received printable files as printable file(s) 364. A PostScript interpreter comprises any system, server, or components operable to translate or decode PostScript statements into executable form and execute the statements. PostScript interpreter 334 may be implemented as one or more processors executing instructions to perform the functionalities of an interpreter. Thus, printing environment 300 is designed to process reduced JDF job ticket(s) 314, default job ticket(s) 362 and PostScript PDL file(s) 364. It is understood, however, that other embodiments in accordance with the invention may process PDL files in a format different from PostScript and may process reduced job tickets in a format different from JDF. Print controller 322 of printing system 320 is operable to process a reduced JDF job ticket. In some embodiments, the default job ticket also may be stored in JDF XML-encoded format. Alternatively, the default job ticket may be encoded in any other suitable internal format for a particular printing system. For example, in some embodiments, default job ticket 362 may be encoded as PostScript operators, as PCL directives, as a binary data file, or as a custom format text file.

In this embodiment, storage system 332, or another memory in print controller 322, stores a JDF interpreter program 336. JDF interpreter program 336 is written in the PostScript language. Because JDF interpreter program 336 is written in PostScript language, PostScript interpreter 334 is able to interpret JDF interpreter program 336 as it would other PostScript programs or files. PostScript interpreter 334 is illustrated in FIG. 3 as including JDF reduced-job-ticket interpreter 344 and PostScript file interpreter 342. JDF interpreter 344 represents the functions or actions performed by PostScript interpreter 334 when interpreting JDF interpreter program 336. JDF reduced-job-ticket interpreter 344 is operable to receive a reduced job ticket that is associated with the printable file from the host system and is operable to build a final job ticket 345 using data from reduced job ticket 314 and default job ticket 362. PostScript file interpreter 342 represents the functions or actions performed by PostScript interpreter 334 when interpreting PostScript printable files to be printed as stored in storage system 332.

In this specification, some language refers to a reduced-job-ticket interpreter that is operable to build a final job ticket using data from the reduced job ticket and the default job ticket. One of ordinary skill in the art will understand that the functionality of applying data from the reduced job ticket in the default job ticket may be implemented using any of a variety of configurations of software and hardware known in the art. One of ordinary skill in the art will also understand that at the type and degree of layout parameters in a default job ticket, a reduced job ticket and a final job ticket may vary widely in various embodiments in accordance with the invention. For example, in some embodiments, a reduced job ticket may contain very few if any changes or additions to complement a default job ticket. On the other hand, in some embodiments, a reduced job ticket may be even larger than the default job ticket. Similarly, in some embodiments, for example, both the reduced job ticket and the default job ticket may specify virtually no layout parameters, so that the layout parameters of a print job are derived from default values of the PDL.

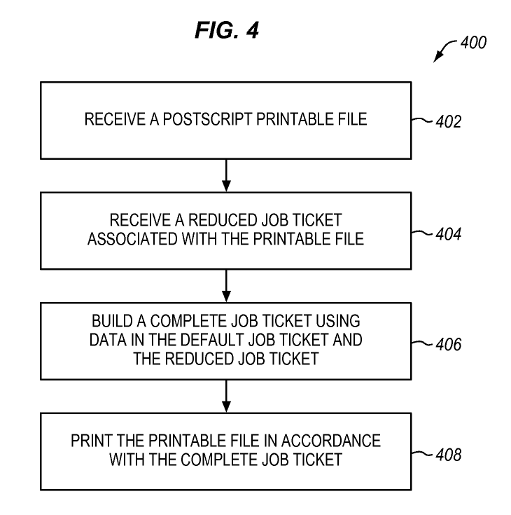

FIG. 4 is a flowchart illustrating a method 400 of processing JDF job tickets in print system 320 in an exemplary embodiment of the invention. The steps of method 400 will be described with reference to printing system 320 in FIG. 3, although method 400 may be performed by other systems. The steps of the flowchart in FIG. 4 are not all inclusive and may include other steps not shown.

In step 402, storage system 332 receives one or more PostScript printable files 364, and stores the files. The PostScript printable files may be received from host system 310 as illustrated in FIG. 3, or may be received from another system or server. At some point, one or more of PostScript printable files 364 are retrieved from storage system 332, and are sent to PostScript interpreter 334 for processing.

In step 404, JDF interpreter 344 receives a reduced JDF job ticket 314 from host system 310 or another system. Reduced JDF job ticket 314 is associated with one or more PostScript printable files 364 stored in storage system 332. As previously mentioned, a reduced JDF job ticket is written in XML format. In step 406, JDF interpreter 344 builds a final job ticket 345 using data from default job ticket 362 stored in storage system 332 and data from reduced job ticket 3 14. In step 408, print controller 322 prints PostScript printable file 364 in accordance with final job ticket 345.

Embodiments of the invention can take the form of an entirely hardware embodiment, an entirely software embodiment or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. For example, the '191 patent describes a computer system suitable for storing and/or executing program code that may be adapted for utilization in accordance with the invention.

Although specific embodiments were described herein, the scope of the invention is not limited to those specific embodiments. The scope of the invention is defined by the following claims and any equivalents thereof.

I claim:

1. A print controller in a printing system, the print controller comprising:
a storage system operable to store a default job ticket; and
a reduced-job-ticket interpreter; wherein
the print controller is operable to receive a printable file from a host system;
the reduced-job-ticket interpreter is operable to receive a reduced job ticket that is associated with the printable file from the host system and is operable to build a final job ticket using data from the reduced job ticket and the default job ticket; and
the print controller is operable to print the printable file in accordance with the final job ticket.

2. The print controller of claim 1 wherein:
the print controller is operable to receive a PostScript printable file from the host system.

3. The print controller of claim 1 wherein:
the reduced-job-ticket interpreter is operable to receive a JDF (Job Definition Format) reduced job ticket.

4. The print controller of claim 1, further comprising:
a page-description-language (PDL) interpreter operable to interpret the printable file.

5. The print controller of claim 4 wherein
the reduced-job-ticket interpreter comprises a program interpreted by the PDL interpreter.

6. The print controller of claim 4 wherein:
the storage system is operable to store a JDF (Job Definition Format) default job ticket;
the print controller is operable to receive a PostScript printable file from the host system; and
the PDL interpreter comprises a PostScript interpreter; and
the reduced-job-ticket interpreter comprises a program interpreted by the PostScript interpreter.

7. The print controller of claim 4 wherein:
the reduced-job-ticket interpreter comprises a JDF interpreter; and
the default job ticket contains PostScript commands that are useful by the reduced-job-ticket interpreter to build the final job ticket.

8. The print controller of claim 4 wherein:
the reduced-job-ticket interpreter comprises a JDF interpreter; and
the default job ticket contains internal format commands that are useful by the reduced-job-ticket interpreter to build the final job ticket.

9. A method of processing job tickets in a printing system, the method comprising:
receiving a printable file from a host system;
receiving a reduced job ticket associated with the printable file;
building a final job ticket using data from the reduced job ticket and data from a default job ticket stored in the printing system; and
printing the printable file in accordance with the final job ticket.

10. The method of claim 9 wherein:
receiving the printable file comprises receiving a PostScript printable file.

11. The method of claim 9 wherein:
receiving the reduced job ticket comprises receiving a reduced JDF job ticket.

12. A computer readable medium tangibly embodying programmed instructions that, when executed on a suitable computer, perform a method of processing job tickets in a printing system, the method comprising:
receiving a printable file from a host system;
receiving a reduced job ticket associated with the printable file;
building a final job ticket using data from the reduced job ticket and data from a default job ticket stored in the printing system; and
printing the printable file in accordance with the final job ticket.

12. The medium of claim 13 wherein:
receiving the printable file comprises receiving a PostScript printable file.

13. The medium of claim 13 wherein:
receiving the reduced job ticket comprises receiving a reduced JDF job ticket.
